(19) United States
(12) Patent Application Publication
(10) Pub. No.: US 2004/0229688 A1
(43) Pub. Date: Nov. 18, 2004

(54) Methods and apparatus for playing video sequences while loading game data

(75) Inventors: Wesley R. Potter, North Vancouver (CA); David Peter John Lucas, Vancouver (CA); Bradley James Gour, North Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronic Arts Inc., Redwood City, CA

(21) Appl. No.: 10/818,648

(22) Filed: Apr. 5, 2004

Related U.S. Application Data
(60) Provisional application No. 60/470,020, filed on May 12, 2003.

(51) Int. Cl. A63F 13/00

(52) U.S. Cl. 463/30

(57) ABSTRACT

Frames of a video sequence are interleaved with game data in a file. When the game is played, the interleaved video frames and the game data may be read from the file where a video sequence corresponding to the video frames is played while the game data is being loaded. When the video sequence has finished, the game data that is needed for a game program has been loaded. In one embodiment, the file may be stored on a medium, such as a compact disk read-only memory (CDROM) or digital versatile disk (DVD).

### CROSS-REFERENCES TO RELATED APPLICATIONS

This application is a Non-Provisional Application of U.S. Provisional Patent Application No. 60/470,020, filed on May 12, 2003. This application is herein incorporated by reference for all purposes.

### BACKGROUND OF THE INVENTION

The present invention relates in general to electronic games and in particular to methods and apparatus for loading and playing video sequences while loading data for a video game.

Video games typically include multiple scenes, adventures, missions, action sequences, and the like. For example, a game may be divided into various scenes a user must complete. A typical scene involves one or more images presented to the user and, in one example, each scene is a level that the player(s) need to complete selected tasks, contests, etc. before being allowed to switch from a current level to a next higher level. Each of these scenes may include different data that a game device may need to load before the scene begins. When a scene change is necessary, the game device loads the data before a new scene can be played. While the data for the new scene is being loaded, a static screen is typically shown for the game. During this time, a user cannot play the game and often ends up doing nothing but watching the static screen.

Displaying a static screen while loading data includes many disadvantages. For example, a user playing the game may lose interest while the game data is being loaded. Also, as games become more complicated, games may include more scenes thus causing more time where a user must wait for data to be loaded. Moreover, loading time increases as games become more complicated because more data must be loaded for each scene. As non-interaction time for a user increases, a user may become frustrated with the slowness of the game and decide not to play the game anymore. This may decrease the popularity of the game, thereby decreasing sales and revenue for the game developers.

### BRIEF SUMMARY OF THE INVENTION

Embodiments of the present invention interleave frames of a video sequence with game data in a file. When the game is played, the interleaved video frames and the game data may be read from the file where a video sequence corresponding to the video frames is played while the game data is being loaded. Once the video sequence has finished, the game data that is needed for a game program should have been loaded. In one embodiment, the file may be stored on a medium, such as a compact disk (CDROM) or digital versatile disk (DVD).

In one embodiment, a method for loading data for a game while playing a video is provided. The method comprises: reading information in a plurality of sections from a file, each section including one of video information and data for a game, the video information and game data being interleaved in the file being read such that the video information may be read and used to play the video while sections including the game data are read and stored; for each section that is read, performing the steps of: determining if the read information is video information or game data; if the information is video information, playing a video using the video information; and if the information is game data, storing the game data for use by a game program for game play by a user.

In another embodiment, a method for creating a file that allows a game device to play a video while loading data for a game is provided. The method comprises: determining video information for the video; determining game data for the game; interleaving sections of the video information with sections of the game data in an interleaved file; and storing the interleaved file on a medium, wherein the game device can load the interleaved parts of video information and game data sequentially and play the video using the video information while loading game data from the file.

In yet another embodiment, a method for reading data for a game and video information from a file is provided. The data and video information is interleaved among each other in sections of the file. The method comprises: (a) reading video information from a first section of the file; (b) playing a video using the read video information; (c) reading game data from a second section of the file while the video is being played; (d) storing the game data; and (e) repeating steps (a)-(d) where sections other than the first and second section are read from the file, wherein video information for the video is read and played while data needed for a portion of the game is read.

In another embodiment, a game device for playing a video game is provided. The game device comprises: a memory; and a game media reader configured to read information from a game media and store the information in the memory, wherein the game media includes an interleaved file that includes game information and video information interleaved in the interleaved filed, wherein the game device is configured to read the game information and video information where the video information is read and played while the game information is read and stored in the memory.

In one embodiment, a computer readable medium that includes embodiments of the present invention is included.

A further understanding of the nature and the advantages of the inventions disclosed herein may be realized by reference of the remaining portions of the specification and the attached drawings.

### BRIEF DESCRIPTION OF THE DRAWINGS

FIG. 1 illustrates a game system for providing one or more games for a user according to one embodiment of the present invention.

FIG. 2 illustrates an embodiment of a game device according to the present invention.

FIG. 3 illustrates a flowchart of a sequence of steps for a game that a user is playing according to one embodiment of the present invention.

FIG. 4 illustrates a system that builds an interleaved file according to one embodiment of the present invention.

FIG. 5 shows how information from A/V information and game data are stored into interleaved file according to one embodiment of the present invention.

FIG. 6 illustrates an embodiment of a section of the interleaved file according to the present invention.

FIG. 7 illustrates a simplified block diagram of the game device used to load information from the interleaved file according to one embodiment of the present invention.

FIG. 8 illustrates a flow chart of a method for retrieving and using information from interleaved file according to one embodiment of the present invention.

### DETAILED DESCRIPTION OF THE INVENTION

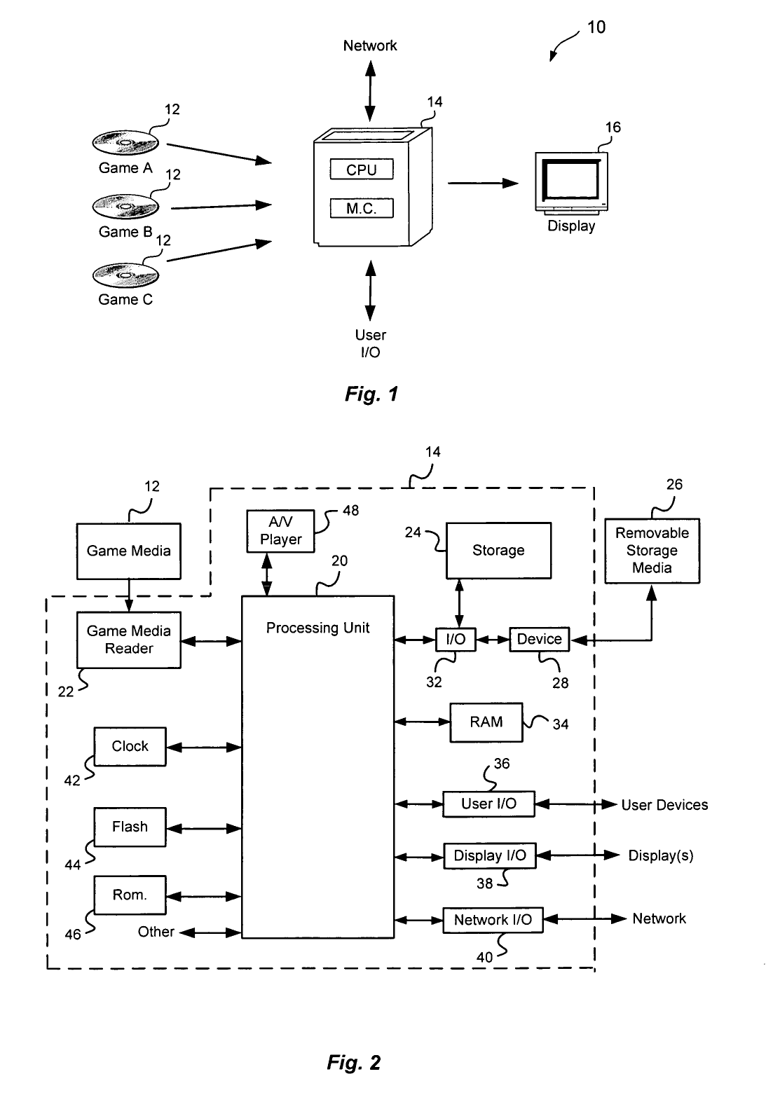

FIG. 1 illustrates a game system 10 for providing one or more games for a user according to one embodiment of the present invention. System 10 is shown including one or more game media 12 (game A, game B, game C), a game device 14, and a display 16.

One or more game media 12 can include any game applications that may be used by game device 14 to involve a user in a game. Each game medium 12 includes logic to provide a game, denoted as game A, game B, and game C. In one embodiment, the game provided by game device 14 is an electronic video game. Games are each individually stored on media, such as compact disk read-only memories (CDROMs), digital versatile disks (DVDs), game cartridges, or other storage media. A game, such as game A, is inserted in, coupled to, or in communication with game device 14 so that game device 14 may read all or part of a game application and/or related game data found on game media 12.

Game device 14 is a computing device that includes a processor, such as a CPU, and data storage combined or in separate elements. Game device 14 may be connected to a network that allows game device 14 to provide games that are not included on one or more game media 12. Thus, game A, game B, and game C may be accessed through the network and not be individually stored on game media 12. To allow a user to select from a plurality of available games, a display 16 might present a list of the games provided by game applications on game media 12. A game application may be also referred to as a game code and/or a game program. A game application should be understood to include software code that game device 14 uses to provide a game for a user to play. A game application might comprise software code that informs game device 14 of processor instructions to execute, but might also include data used in the playing of the game, such as data relating to constants, images and other data structures created by the game developer. A user interacts with the game application and game device 14 through user input/output (I/O) devices.

FIG. 2 illustrates an embodiment of game device 14 according to embodiments of the present invention. It should be understood that other variations of game device 14 may be substituted for the examples explicitly presented herein. As shown, game device 14 includes a processing unit 20 that interacts with other components of game device 14 and also interacts with external components to game device 14. A game media reader 22 is included that communicates with game media 12. Game media reader 22 may be a CDROM or DVD unit that reads a CDROM, DVD, or any other reader that can receive and read data from game media 12.

Game device 14 also includes various components for enabling input/output, such as an I/O 32, a user I/O 36, a display I/O 38, and a network I/O 40. I/O 32 interacts with a storage 24 and, through a device 28, removable storage media 26 in order to provide storage for game device 14. Processing unit 20 communicates through I/O 32 to store data, such as game state data and any shared data files. In addition to storage 24 and removable storage media 26, game device 14 includes random access memory (RAM) 34. RAM 34 may be used for data that is accessed frequently, such as when a game is being played.

User I/O 36 is used to send and receive commands between processing unit 20 and user devices, such as game controllers. Display I/O 38 provides input/output functions that are used to display images from the game being played. Network I/O 40 is used for input/output functions for a network. Network I/O 40 may be used if a game is being played on-line or being accessed on-line.

Game device 14 also includes other features that may be used with a game, such as a clock 42, flash memory 44, read-only memory (ROM) 46, and other components. An audio/video player 48 is also used to play a video sequence such as a movie. It should be understood that other components may be provided in game device 14 and that a person skilled in the art will appreciate other variations of game device 14.

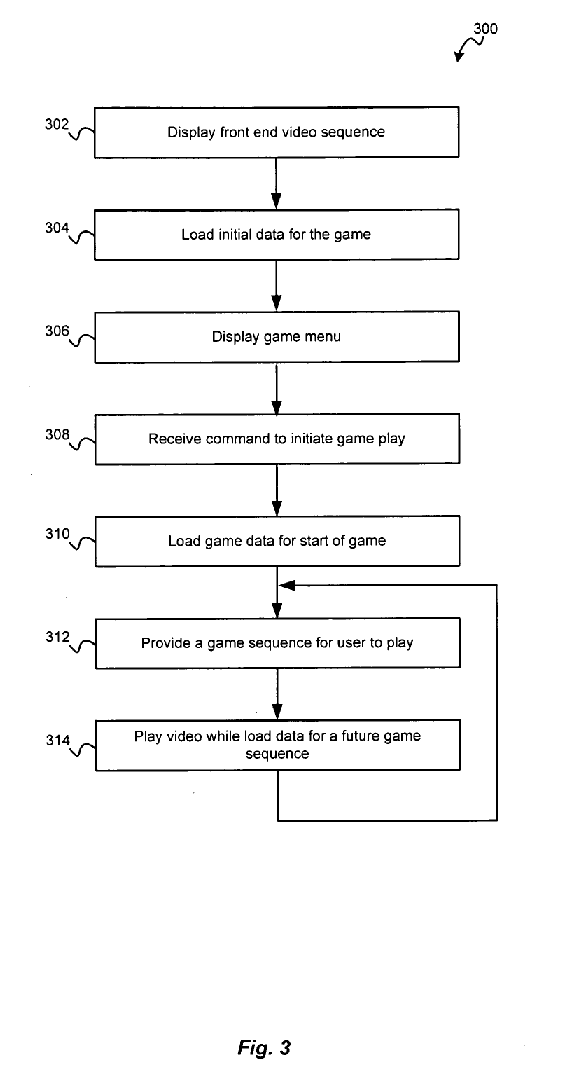

FIG. 3 illustrates a flowchart 300 of a sequence of steps for a game that a user is playing according to one embodiment of the present invention. In step 302, a front end video sequence is displayed. The front end video sequence provides an initial introduction to the game.

When the video sequence is over, in step 304, initial data is loaded for the game. Although it is described here that a front-end video sequence is played and then data is loaded for the game, it should be understood that embodiments of the present invention may be used where the video sequence is played while the data is loaded. However, for the purposes of discussion, the front-end video sequence is played and then data is loaded for the game. This initial data is typically data that is used to provide a game menu and any initial options before a game is played.

In step 306, a game menu is provided. The game menu allows a user to choose from different options, such as starting a game, performing training, creating different players, and other options.

In step 308, a command is received to initiate game play. The command may indicate that the game should start at the beginning of the game or at a specific scene, game state, scenario, etc. Alternatively, game device 14 may decide where to start the game based on game state information.

In step 310, data for the game is loaded before the start of the game. For example, game data may be loaded for the first scene of the game or any other scene. Although the term scene is used, it should be understood that a scene may be any sequence, such as a mission, action sequence, etc. In one embodiment, a first scene may be defined by a game sequence that requires data to be loaded and a second scene is defined by another game sequence that requires its own data to be loaded after the first scene has been completed. In one embodiment, because of memory limitations, data may only loaded for the current scene that will be played by the user.

In step 312, a game sequence is provided for the game using the data that was loaded in step 310. For example, a user plays the scene of the game associated with the data that was loaded. Typically, goals or requirements are accomplished by the user and, in some cases, the user may reach a point where a new scene is required. When that happens, the game device needs to load new data for the new scene.

In step 314, a video sequence is played while the new data is loaded for a future game sequence. By playing video while the new data is loaded, it gives the user the perception that the game is still being played. Instead of providing a static screen where the user does nothing, a video is provided that the user can watch and typically engage the user. The video may make it appear that the user is still playing the game even though no user interaction is required while the video is playing. In some instances, the video may provide an observant user with essential information that might be needed in future levels, thus making the video more compelling and more convincingly an essential element of the play of the game.

The method then reiterates to step 312 where the game is provided for a user to play. When the user completes the scene that data was loaded for, additional data will be loaded for another scene while a video is being played.

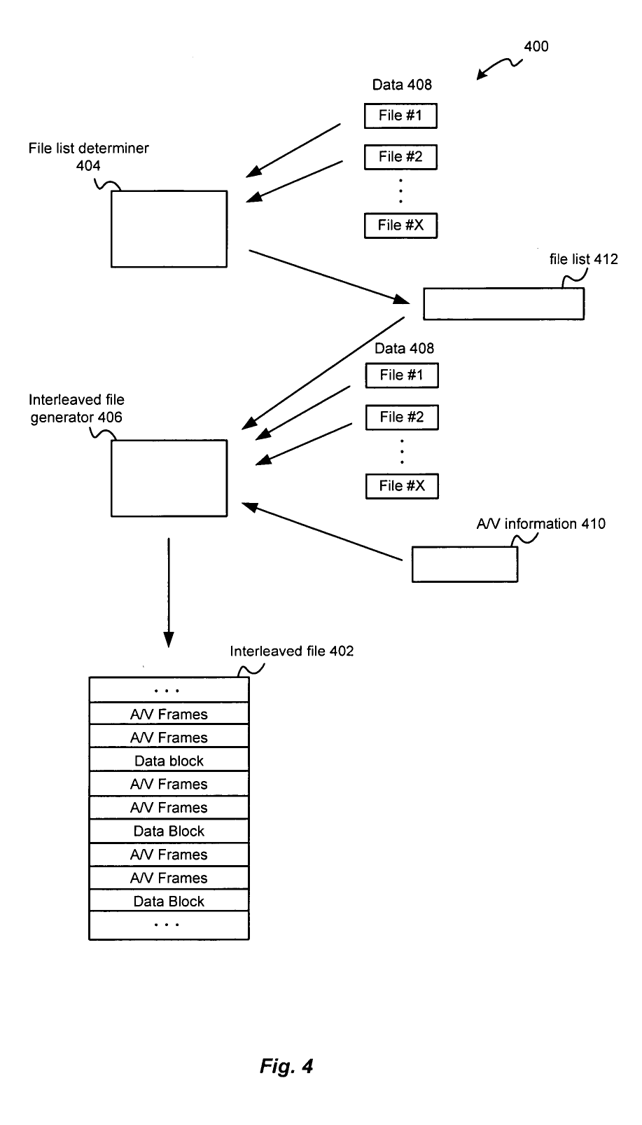

In one embodiment, an interleaved file that includes video information and data for the game interleaved among each other is created. The file enables game device 14 to load and display a video sequence while loading data for the next scene of the game. FIG. 4 illustrates a system 400 that builds an interleaved file 402 according to one embodiment of the present invention. As shown, a file determiner 404 and an interleaved file generator 406 use data 408 and audio/video (ANV) information 410 to generate interleaved file 402.

Data 408 includes any data that is needed by game device 14 to provide a game. For example, data 408 may include libraries, game data, character data, software code, or any other information that is needed by a game program for the game. The game program includes software code that uses data 408 to generate different scenes in a game for a user to play. In one embodiment, the game program is configured to use certain data in data 408 for each scene.

As shown, data 408 is divided into files labeled as file #1, file #2, . . . , and file #X. In one embodiment, data from each file may be used in a different scene in the game or data from multiple files may be used in a scene. For example, each file may be a different entity for a scene. A first file may be the sound track for the scene, a second file may be information for a character used in the scene, a third file may be information for an object in the scene, etc.

File list determiner 404 is configured to build a file list 412, which is a list of files that may be needed by the game program. The list of files is deterministic and represents the data that may be needed by the game program when it is run. The list of files is determined because files are read in linear order in one embodiment. Thus, for example, each scene may need specific files and those files should be loaded before the scene is played. A test game program may then be run to determine the files that may be needed for each scene and the file list is determined.

In one embodiment, file list 412 may be a list of file names, such as file #1, file #2, etc. If a file number is specified, data from the file may be broken into sections and interleaved with A/V information 410 in file 402. Also, file list 412 may indicate that certain parts of files should be included in the final interleaved file 402. For example, file list 412 may indicate the following sections should be included: a first section of file #1, a second section of file #1, a first section of file #2, etc.

In one embodiment, file determiner 404 may determine if a file or part of a file is temporary or permanent data. If a file is determined to include temporary data, file determiner 404 may cause the file that includes temporary data to be inserted into file list 412 in a temporary section. Also, files with permanent data are inserted in a permanent file section. In one embodiment, permanent data may be data that is used for the scene and not deleted and temporary data is data that is used for a part of the scene and then deleted. For example, files that include permanent data may be inserted at the beginning of file list 412.

When creating interleaved file 402, a marker may be inserted in interleaved file 402 that indicates that all files after the marker include temporary data. Temporary data is then inserted after the marker along with other temporary data. Permanent data are then inserted before the marker.

Accordingly, when data from interleaved file 402 is read, permanent data is read into memory first and then temporary data. Thus, when temporary data is deleted from memory, memory fragmentation is avoided. For example, if temporary data was interlaced with permanent data in memory, many holes in memory would exist after temporary data were deleted. However, if all temporary data are stored in memory in the same location, it is possible that only one hole in memory may exist after all temporary data have been deleted.

When file list 412 has been completed, interleaved file generator 406 reads file list 412 and is configured to generate interleaved file 402. Generator 406 interleaves data 408 and audio/video information 410 into file 402. Audio/video (A/V) information 410 includes any audio/video information that will be used to display a video or movie during game play. For example, frames of audio and video are interleaved with data 408. Although audio/video information 410 is described as including audio and video information, it will be recognized that only video or only audio information may be used.

In one embodiment, interleaved file 402 is a single binary file where data is extracted in order or linearly. Interleaved file 402 may be included on a linear storage medium, such as a compact disk (CDROM) or a digital versatile disk (DVD). In one embodiment, information is read from the linear storage medium in a linear or sequential fashion. In a typical linear storage device, the reading of data is done as a stream of data and switching from one location on a medium to a nonconsecutive location on the medium takes enough time that switching back and forth would lower the throughput of the storage device such that data could not be read quickly enough, such as quickly enough to display video data in real-time. In some non-linear storage media, such as desktop computer hard drives, reads may be done at two different areas in the hard drive at the same time or consecutive reads may be performed in non-sequential locations without unacceptable degradation in throughput or unacceptable increase in latency. With non-linear storage media, video data and game data might not need to be interleaved if audio/video information can be read from one area and game data read from another area at the same time, or at least perceived by the user as being at the same time. With the typical CD or DVD, it is not feasible to read from more than one stream at a time, as those media were developed to be read sequentially and non-sequential reads might not even be supported.

In one example of creating interleaved video and game data, interleaved file generator 406 determines a first file from file list 412 and interleaves data blocks or sections from the first file with A/V information 410. For example, if A/V information 410 is for a video sequence (possibly including an audio sequence) that will be played between scenes, information needed for the next scene is retrieved from file #1 and file #2 and sections of data are interleaved with frames for the video sequence.

When all the A/V information for the first video sequence has been written to file 402, a second video sequence for another scene transition may be written to file 402. Interleaved file generator 406 reads file list 412 to determine data 408 that needs to be loaded while the second video sequence is being played. This is data that may be used for a scene being played after the second video sequence has finished. In one example, interleaved file generator 406 interleaves data from another file, such as file #X, with information from a second video sequence into file 402.

Although one interleaved file 402 is shown, it should be understood that multiple interleaved files may be generated. For example, an interleaved file for each separate scene may be generated. A game program will then read a different file for each scene transition.

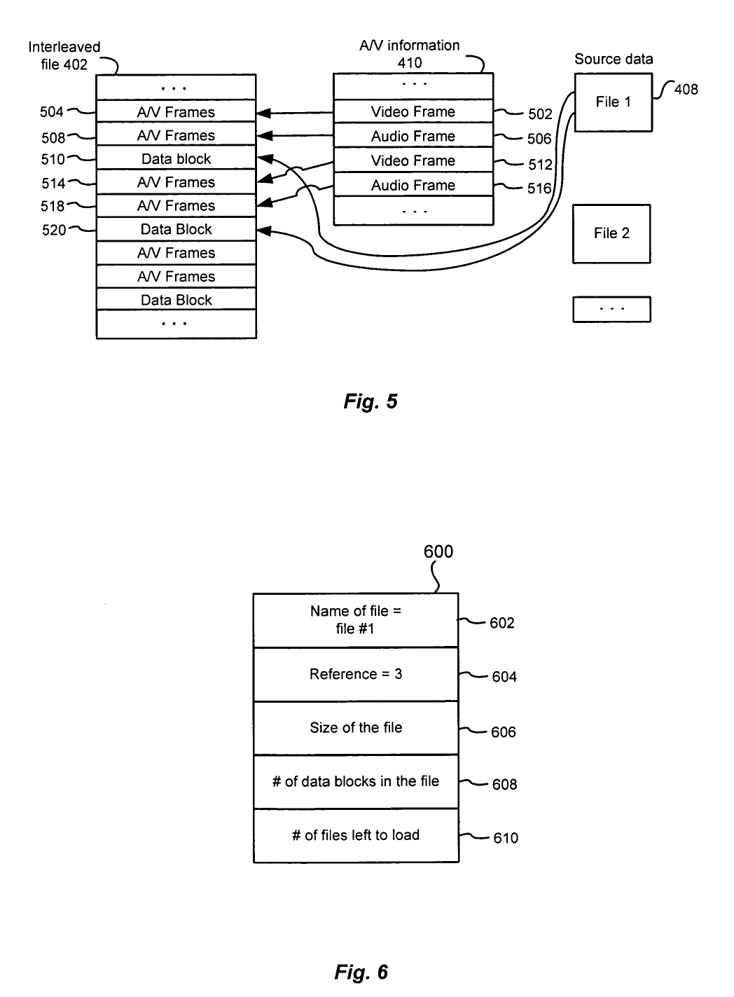

FIG. 5 shows how information from A/V information 410 and data 408 are stored into interleaved file 402 according to one embodiment of the present invention. As shown, audio/video information 410 includes a plurality of video and audio frames that are used to play a video sequence or movie. In generating file 402, a first video frame 502 from A/V information 410 is stored in interleaved file 402 in a first section 504. A first audio frame 506 is then stored in a second section 508 in interleaved file 402. In one embodiment, each successive section of file 402 is a sequential block that may be read in order. For example, section 504 may be read first, followed by section 506, and so on.

After the two A/V frames are written into sections 504 and 508, a data block from file #1 is written in a third section 510. In one embodiment, data block 510 is a section of data from file #1 that has been encoded and compressed. Although a data block or section of file #1 is written into file 402, it should be understood that any amount of data 408 may be written into file 402, such as file #1, any part of file #1, any part of file #2, all of file #1 and file #2, or any other combination of data 408.

Next, a video frame 512 is written into a fourth section 514 and an audio frame 516 is written into a fifth section 518 in file 402. Another data block is retrieved from file #1 and written into a sixth section 520. This process continues until all necessary audio and video frames in A/V information 410 and data from data 408 have been written into interleaved file 402. For example, A/V information for a video sequence that may be played before a scene and data that is needed for the scene may be written into file 402. Also, A/V information and data for multiple scenes or parts of scenes my be written to file 402. In this case, the above process continues with additional A/V information 410 and data 408 being interleaved into file 402.

Although interleaved file 402 is shown with a sequence of two A/V frames, one data block, two A/V frames, one data block, etc., it should be understood that any combination of interleaved data and A/V information may be used. For example, the ratio of audio and/or video frames to data blocks as well as the size of the data blocks are dependent on a movie playback rate and for a target transfer rate of data from interleaved file 402 to gaming device 14. For example, A/V information 410 and data 408 are interleaved where A/V information can be retrieved and played continuously while data blocks are retrieved and stored. In one example, a video frame may take 10 milliseconds (ms) to load, a data block 5 ms, and a next video frame 10 ms. The video frame will play a video that is more than 25 ms long in order for the next video frame to load and begin playing.

Sections of interleaved file 402 may be formatted as they are written into interleaved file 402. FIG. 6 illustrates an embodiment of a header 600 for data blocks of a file according to the present invention. In one embodiment, header 600 is associated with data block file #1. Header 600 is used in reading data blocks in a file. Before a data block from a file is interleaved into interleaved filed 402, header 600 is generated and stored before the data blocks of the file. Header 600 is then used to determine the name of the file, how many blocks of data to read for the file, and other information for the file.

As shown, header 600 includes a first section 602 that represents the name of a file associated with header 600. For example, the name of the file may represent the file number the data originated from (e.g., file #1) or a scene that will use the data.

A second section 604 is also appended and indicates the number of times the file will be accessed by a game program. The reference count is used to determine if the file can be removed from memory during game operation. This allows memory to be cleared and other data to be loaded. For example, when data for the file is first retrieved by a game program, it may be stored in cache memory. The reference count is four, which means that the file will be accessed four times by the game program. Each time the file is accessed, the reference count is decremented by one. When the count reaches zero, the file may be removed from memory because it will not be accessed again.

In one embodiment, when file list 412 was created, a test program is run to determine which data are needed for each scene. The test program is a replication of how an actual game program for the game may run. The test program also may determine the reference count. Each time the test program accesses the same file, the reference count is increased. Thus, before the game program is run in game device 14, the number of times each file may be accessed by the game program is known.

A third section 606 indicates the size of file after the file is recreated. The size of the file is the size after all blocks for the file have been loaded.

Also, fourth section 608 indicates the number of data blocks that the file includes. In this case, there are four data blocks in the file. This may indicate that there may be four audio/video blocks to load, four data blocks to load, four files to load, or any other combination thereof. After header 600, there may be four blocks of data before another header is encountered. The next header includes information for the next file.

A fifth section 610 indicates how many files are left to load. In one embodiment, a movie may be longer than the time needed to load data blocks. Accordingly, an option may be given to a user to ship the remaining part of the movie when all data for the scene has been loaded. When the number of files left to load reaches zero, then the rest of a movie that has yet to be played may be skipped.

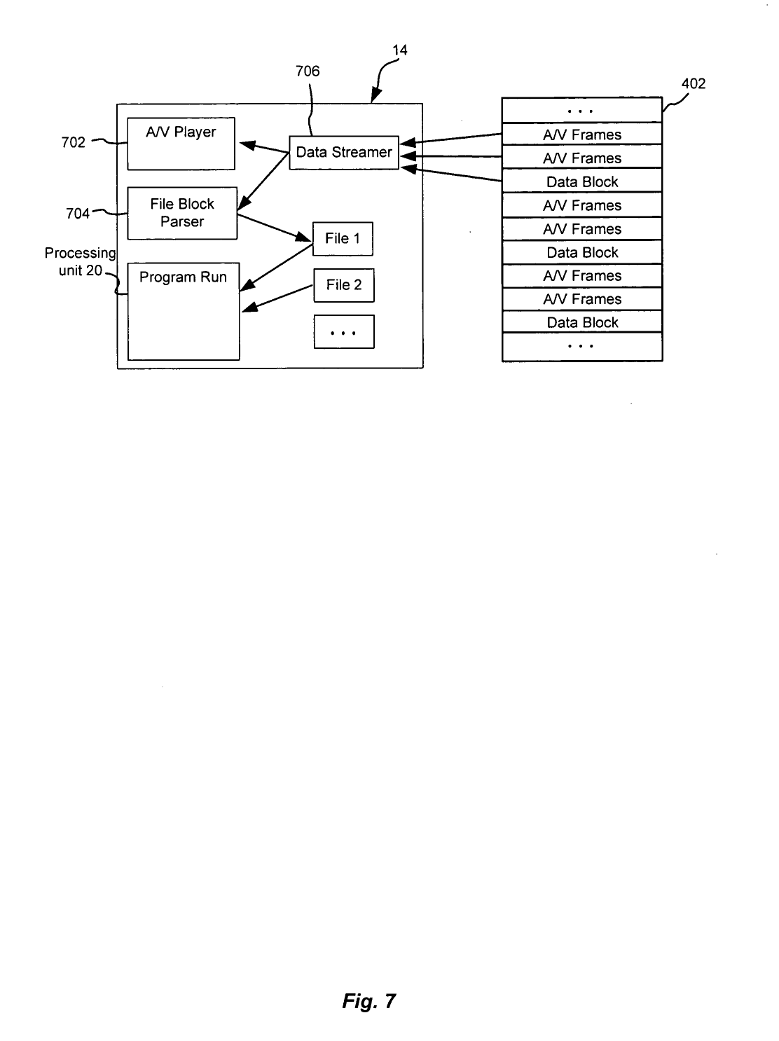

FIG. 7 illustrates a simplified block diagram of game device 14 used to load information from the interleaved file according to one embodiment of the present invention. As shown, game device 14 includes audio/video player 48, processing unit 20, a file block parser 704, and a data streamer 706.

Data streamer 706 reads information from interleaved file 402. In one embodiment, sections from interleaved file 402 are read in a sequential order. Depending on the type of section, data streamer 706 either sends a section to A/V player 48 or file block parser 704. If the section is an A/V frame, the frame is sent to A/V player 48 and if the section is a data block, it is sent to file block parser 704. In one embodiment, an identifier or token is included in the section that indicates whether the section is audio, video, or data.

A/V player 48 plays the video and/or audio frames on a display as they are received from data streamer 706. In one embodiment, A/V player 48 receives frames from data streamer 706 so that a video can be continuously played while data blocks are being read from file 402.

As the video is being played using the streamed A/V frames, data blocks are read and sent to file block parser 704, which recombines the blocks to build them into the original files, such as file #1, file #2, etc. Although it is described that file block parser 704 may recombine the data blocks, it should be understood that each individual data block may correspond to file #1, file #2, etc. or any combination thereof. In one embodiment, file block parser 704 decompresses the data blocks and using the size of each file, waits until a number of data blocks will fill a file and then concatenates the blocks when there are enough to fill the file. The recreated file is then linked to other files in memory, such as a global list of files in RAM 34. The link may also include a file name, size, reference count, etc. Processing unit 20 is then directed to use the linked list to retrieve data for the game program.

When the movie being played by A/V player 48 has finished, all the data needed from interleaved file 402 has been loaded and stored in file #1, file #2, etc. The game program is then ready to provide a new game sequence using the extracted data. For example, the user can now play a new scene for the game.

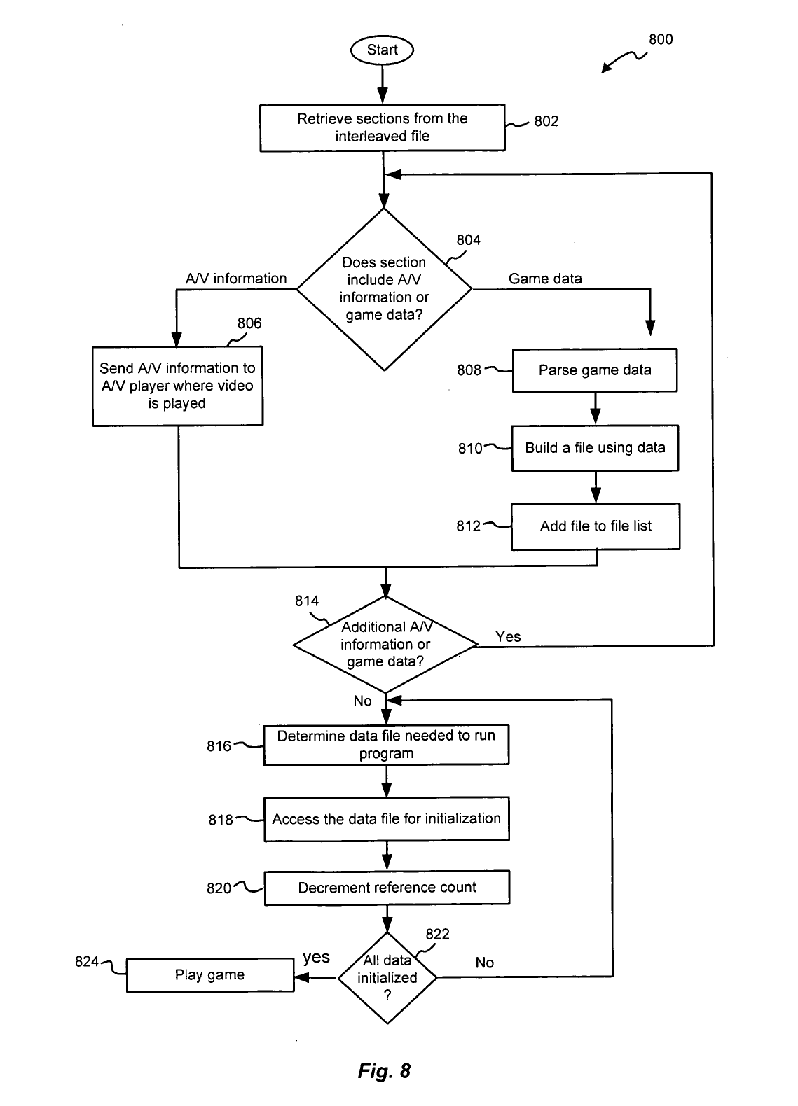

FIG. 8 illustrates a flow chart 800 of a method for retrieving and using information from interleaved file 402 according to one embodiment of the present invention. The method begins when a scene has ended and a new scene should be started. In step 802, sections from interleaved file 402 are retrieved. In one embodiment, the sections are retrieved in a sequential order where each section may be A/V information or a data block.

In step 804, it is determined whether the section is A/V information 410 or game data 408. If the section includes A/V information 410, in step 806, A/V information 410 is sent to A/V player 48 and a video sequence is played.

If the section includes the game data, in step 808, the game data is sent to file block parser 702. In one embodiment, a header 600 may be parsed to determine a file name, the size of the file, the number of data blocks in a file, and any other information described above. In step 810, the game data is rebuilt into a file. A file may be built if enough blocks of data have been retrieved. If the game data received is not enough to build a file, the game data may be stored until enough game data is received.

In step 812, if a file is built in step 810, the file is added to a list of files. The list of files is used by a game device when playing the game. As the game is played, files from the list are read and retrieved.

The method then continues at step 814, where it is determined whether additional A/V information 410 or game data 408 should be read. If so, the method reiterates to step 804 and the process continues with a new block of A/V information 410 or game data 408.

In one embodiment, game data is sent to file block parser 702 while A/V player 48 plays A/V information 410. Accordingly, although steps 806 and 808-812 are described separately, it will be understood that the playing of A/V information 410 in step 806 may occur while game data is loaded in steps 808-812.

When additional A/V information 410 or game data 408 is not needed, in one embodiment, a movie has been played and all game data that is needed for a new scene has been loaded. Thus, when the new scene is started, no new data may be needed for game play until another new scene is encountered.

In step 816, data initialization for game play starts and the game program determines a data file needed for the game. For example, the program may determine that data in a file #1 is needed from the list of files generated in step 812. When the data is initialized in step 818, it is used by the program in providing the game to a user. Also, a reference count for the file is decremented in step 820. The reference count indicates how many times the file may be accessed by the program. If the reference count is zero, the file may then be deleted from memory because it is no longer needed. For example, the file may have been loaded into cache memory and is stored in cache until the file is no longer needed (the reference count is zero).

In step 822, the process determines if all game data has been initialized. In this case, a scene may have been completed and new data may need to be loaded. If all data has not been initialized, the method reiterates to step 816, where the initialization process is continued. After all data has been initialized, the game may be played in step 824. The process may be started at step 802 when a scene has ended and new data is needed.

Accordingly, embodiments of the present invention allow a video to be loaded and played while data is being loaded from a file in a medium, such as a CD-ROM or DVD. This gives the perception to a user that a game is still being played even though no interaction is required from the user. For example, the movie may show a video sequence that provides a transition from a first scene to a second scene while the data for the second scene is being loaded. Although the user cannot interact with the game program while the video is being played, a static screen is not being shown to the user; rather, a movie that may keep the attention of the user is shown.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof.

The above description is illustrative but restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for loading data for a game while playing a video, the method comprising:
reading information in a plurality of sections from a file, each section including one of video information and data for a game, the video information and game data being interleaved in the file being read such that the video information may be read and used to play the video while sections including the game data are read and stored;
for each section that is read, performing the steps of:
determining if the read information is video information or game data;
if the information is video information, playing a video using the video information; and
if the information is game data, storing the game data for use by a game program for game play by a user.

2. The method of claim 1, further comprising:
when the information in the game data has been read, enabling a user to play the game using the game data.

3. The method of claim 1, further comprising determining when a video sequence should be played and in response, performing the step of reading information.

4. The method of claim 3, wherein determining when to play the video sequence comprising determining when a scene has changed.

5. The method of claim 1, wherein the file is stored on at least one of a CD-ROM and digital versatile disk (DVD).

6. A method for creating a file that allows a game device to play a video while loading data for a game, the method comprising:
determining video information for the video;
determining game data for the game;
interleaving sections of the video information with sections of the game data in an interleaved file; and
storing the interleaved file on a medium, wherein the game device can load the interleaved parts of video information and game data sequentially and play the video using the video information while loading game data from the file.

7. The method of claim 6, further comprising running a program to determine a list of files that include the game data that are needed for the game.

8. The method of claim 7, further comprising using the list to determine the files needed for the game, wherein game data from the files are interleaved with the parts of video information.

9. The method of claim 7, further comprising generating a header for a file in the one or more files.

10. The method of claim 9, further comprising generating a reference count for header, the reference list indicating a number of times the file may be accessed by the game device.

11. The method of claim 9, further comprising generating a data block count for the header, the data block count indicating how many data blocks are included in the file.

12. The method of claim 9, further comprising generating a number that indicates the number of files left to load number for the header.

13. The method of claim 9, further comprising generating a number that indicates the size of the file for the header.

14. The method of claim 6, wherein the medium comprises at least one of a CD-ROM and a DVD.

15. A method for reading data for a game and video information from a file, the data and video information interleaved among each other in sections of the file, the method comprising:
(a) reading video information from a first section of the file;
(b) playing a video using the read video information;
(c) reading game data from a second section of the file while the video is being played;
(d) storing the game data; and
(e) repeating steps (a)-(d) where sections other than the first and second section are read from the file, wherein video information for the video is read and played while data needed for a portion of the game is read.

16. The method of claim 15, wherein the video information and game data is read in an alternating sections so that a video can be played continuously while game data is read and stored.

17. The method of claim 15, further comprising enabling a user to play the portion of the game using the stored game data.

18. The method of claim 15, wherein storing the data comprises linking the data with other data that has been stored.

19. The method of claim 15, wherein the file is stored on at least one of a CD-ROM and digital versatile disk (DVD).

20. A game device for playing a video game, the game device comprising:
a memory; and
a game media reader configured to read information from a game media and store the information in the memory, wherein the game media includes an interleaved file that includes game information and video information interleaved in the interleaved filed,
wherein the game device is configured to read the game information and video information where the video information is read and played while the game information is read and stored in the memory.

21. The game device of claim 20, further comprising a video player configured to play the video information.

22. The game device of claim 20, wherein the memory comprises at least one of RAM and ROM.

23. The game device of claim 20, wherein the game media comprises at least one of a CD-ROM and DVD.

24. A computer readable medium for loading data for a game while playing a video, the computer readable medium comprising:
code for reading information in a plurality of sections from a file, each section including one of video information and data for a game, the video information and game data being interleaved in the file being read so that the video information can be read and used to play the video while sections including the game data are read and stored;
for each section that is read, the computer readable medium including:
code for determining if the read information is video information or game data;
if the information is video information, code for playing a video using the video information;
if the information is game data, code for storing the game data for use by a game program for game play by a user.

25. The computer readable medium of claim 24, further comprising:
when the information in the game data has been read, code for enabling a user to play the game using the game data.

26. The computer readable medium of claim 24, further comprising code for determining when a video sequence should be played and in response, code for performing the step of reading information.

27. The computer readable medium of claim 26, wherein the code for determining when to play the video sequence comprises code for determining when a scene has changed.

28. The computer readable medium of claim 24, wherein the file is stored on at least one of a CD-ROM and digital versatile disk (DVD).

29. A computer readable medium for reading data for a game and video information from a file, the data and video information interleaved among each other in sections of the file, the computer readable medium comprising:
(a) code for reading video information from a first section of the file;
(b) code for playing a video using the read video information;
(c) code for reading game data from a second section of the file while the video is being played;
(d) code for storing the game data; and
(e) code for repeating steps (a)-(d) where sections other than the first and second section are read from the file, wherein video information for the video is read and played while data needed for a portion of the game is read.

30. The computer readable medium of claim 29, wherein the video information and game data is read in an alternating sections so that a video can be played continuously while game data is read and stored.

31. The computer readable medium of claim 29, further comprising code for enabling a user to play the portion of the game using the stored game data.

32. The computer readable medium of claim 29, wherein the code for storing the data comprises code for linking the data with other data that has been stored.

33. The computer readable medium of claim 29, wherein the file is stored on at least one of a CD-ROM and digital versatile disk (DVD).
